(19) United States
(12) Patent Application Publication
(10) Pub. No.: US 2019/0265098 A1
(43) Pub. Date: Aug. 29, 2019

(54) OPTICAL ATTENUATOR ASSEMBLY

(71) Applicant: Appleton Grp LLC, Rosemont, IL (US)

(72) Inventors: Padmanabh Pandurang Gawai, Pune (IN); Pushkar Satish Barve, Pune (IN)

(21) Appl. No.: 16/270,815

(22) Filed: Feb. 8, 2019

(30) Foreign Application Priority Data
Feb. 27, 2018 (IN) 201821007345

(51) Int. Cl. G01J 1/04; G01J 1/06; G01J 1/42

(52) U.S. Cl. CPC G01J 1/0418; G01J 2001/446; G01J 1/42; G01J 1/06

(57) ABSTRACT

The present disclosure envisages an optical attenuator assembly which is compact and cost effective. The optical attenuator assembly comprises a protective layer, an attenuation layer, and a vinyl layer. The protective layer has a cavity configured thereon to facilitate reception of a sensor mounted on a base. The attenuation layer is deposited on the protective layer, and is configured to attenuate the intensity of incident light rays. The attenuation layer is further configured to provide attenuated light rays to the sensor. The vinyl layer is deposited on the attenuation layer. The vinyl layer has a window configured thereon to facilitate the light rays to incident on the attenuation layer, and is further configured to limit the angle of incident of the light ray with respect to the sensor.

### RELATED APPLICATIONS

This application claims priority to Indian Application No. 201821007345 entitled “An Optical Attenuator Assembly” filed on Feb. 27, 2018, the contents of which are incorporated by reference herein in their entirety.

### FIELD

The present disclosure relates to the field of optical attenuators.

### BACKGROUND

Typically, optical sensors are required for determining the performance characteristic of a luminaire being tested. These optical sensors are required to be positioned in the proximity of the luminaire being tested. Each optical sensor is distinctly positioned at a particular angle with respect to the luminaire. However, the optical sensors have a defined maximum light sensing window. Mostly, the luminaire under test has a very high light intensity which may be greater than forty thousand lux. However, due to the operating limitation of the optical sensors, the optical sensors tend to saturate upon exposure to such high light intensities. The level of attenuation required is around 75 percent in order to enable the optical sensors to perform the desired task.

Further, in many applications, the optical attenuators are required to be mounted on an arcuate base in order to maintain a desired angle with the luminaire being tested. However, the conventional optical attenuators are glass based attenuators, and therefore, are not flexible enough to be easily fitted on the arcuate base. Additionally, the conventional optical attenuators fail to protect the sensor from physical damage caused due to any external forces, fail to achieve the desired Field of View (FOV), and are bulky and costly.

Therefore, there is a need of an optical attenuator assembly that alleviates the aforementioned problems.

### OBJECTS

Some of the objects of the present disclosure, which at least one embodiment herein satisfies, are as follows.

It is an object of the present disclosure to ameliorate one or more problems of the prior art or to at least provide a useful alternative.

An object of the present disclosure is to provide an optical attenuator assembly.

Another object of the present disclosure is to provide an optical attenuator assembly that is cost effective.

Still another object of the present disclosure is to provide an optical attenuator assembly which is not bulky.

Yet another object of the present disclosure is to provide an optical attenuator assembly that prevents a sensor being tested from damage due to external forces.

Still another object of the present disclosure is to provide an optical attenuator assembly which provides sufficient field of view (FOV).

Yet another object of the present disclosure is to provide an optical attenuator assembly that has a certain amount of flexibility.

Still another object of the present disclosure is to provide an optical attenuator assembly that can be easily serviced.

Yet another object of the present disclosure is to provide an optical attenuator assembly that can be reused for various types of light sensors.

Other objects and advantages of the present disclosure will be more apparent from the following description, which is not intended to limit the scope of the present disclosure.

### SUMMARY

The present disclosure envisages an optical attenuator assembly. The optical attenuator assembly comprises a protective layer, an attenuation layer, and a vinyl layer. The protective layer has a cavity configured thereon to facilitate reception of a sensor mounted on a base. In an embodiment, the base is an arcuate shaped base. The attenuation layer is deposited on the protective layer, and is configured to attenuate the intensity of incident light rays. The attenuation layer is further configured to provide attenuated light rays to the sensor. The vinyl layer is deposited on the attenuation layer. The vinyl layer has a window configured thereon to facilitate the light rays to incident on the attenuation layer, and is further configured to limit the angle of incident of the light rays with respect to the sensor.

In an embodiment, the attenuation layer comprises a frosted acrylic film and an attenuation film. The frosted acrylic film faces the window defined by the vinyl layer. The frosted acrylic film is configured to provide a first level of attenuation to the incident light rays. The attenuation film is disposed on an operative top surface of the frosted acrylic film, and is configured to provide a second level of attenuation to the first level attenuated incident light rays.

In an embodiment, the protective layer is configured to provide a cushioning effect to the sensor, and is further configured to prevent the sensor from damage due to external forces. In another embodiment, the height of the protective layer is greater than the height of the sensor, and is configured to vary the distance between the sensor and the window so as to achieve the desired field of view.

In an embodiment, the length of the window is directly proportional to the distance between the sensor and the window. In another embodiment, the length of the window is in the range of 6 mm to 15 mm.

In still another embodiment, the vinyl layer is configured to limit the angle of incident of the incident light rays up to +/−20 degrees with respect to the sensor.

In an embodiment, the material used for manufacturing the protective layer is selected from the group consisting of silicon rubber and polyurethane rubber.

In another embodiment, the height of the protective layer and the attenuation layer is in the range of 1.5 mm to 2.5 mm respectively.

In an exemplary embodiment, the optical attenuator of the present disclosure is used for an array of sensors mounted in a spaced apart configuration on an arcuate shaped base.

### BRIEF DESCRIPTION OF THE ACCOMPANYING DRAWING

An optical attenuator assembly of the present disclosure will now be described with the help of the accompanying drawing, in which:

FIG. 1 illustrates a schematic view of an optical attenuator assembly for a sensor mounted on a base;

FIG. 2 illustrates a schematic view of the optical attenuator of FIG. 1 mounted on an arcuate base in accordance with an embodiment of the present disclosure.

FIG. 3 illustrates a side view of the optical attenuator of FIG. 1 mounted on the arcuate base of FIG. 2.

FIG. 4 illustrates a sensitivity graph of the sensor for various angle of incident.

### LIST OF REFERENCE NUMERALS USED IN DETAILED DESCRIPTION AND DRAWING

100—Optical attenuator assembly
102—Base
104—Protective layer
106—Sensor
108—Vinyl layer
108a—Window
110—Attenuation layer
110a—Attenuation film
110b—Frosted acrylic film

### DETAILED DESCRIPTION

The conventional optical attenuators are typically glass based attenuators, and therefore, are not flexible enough to be easily fitted on the arcuate base. Additionally, the conventional optical attenuators fail to protect the sensor from physical damage caused due to any external forces, fail to achieve the desired Field of View (FOV), and are bulky and costly.

The optical attenuator assembly of the present disclosure is cost effective, light in weight, and provides sufficient flexibility.

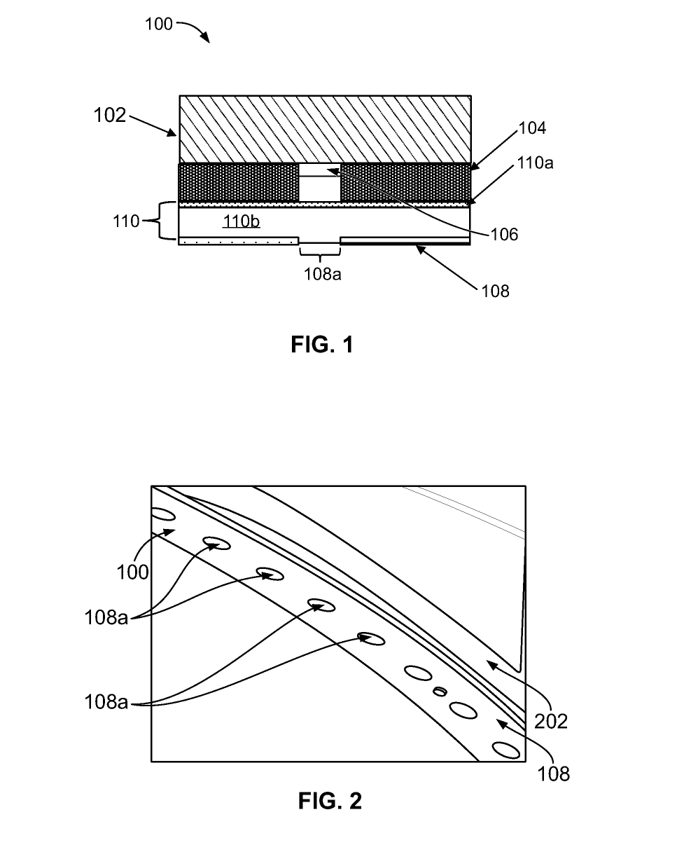

A preferred embodiment of an optical attenuator assembly 100, of the present disclosure will now be described in detail with reference to FIG. 1 through FIG. 4. The preferred embodiment does not limit the scope and ambit of the disclosure.

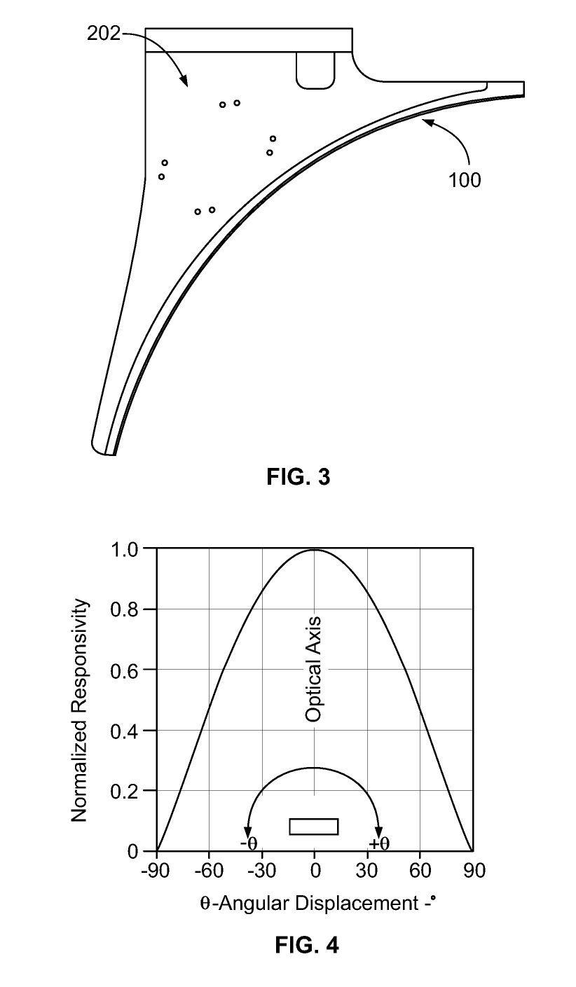

FIG. 1 illustrates a schematic view of the optical attenuator assembly 100 for a sensor 106 mounted on a base 102. FIG. 2 illustrates a schematic view of the optical attenuator assembly 100 mounted on an arcuate base 202 in accordance with an embodiment of the present disclosure. FIG. 3 illustrates a side view of the optical attenuator assembly 100 mounted on the arcuate base 202. FIG. 4 illustrates a sensitivity graph depicting response of the sensor 106 at various angle of incident.

The optical attenuator assembly 100 of the present disclosure comprises a protective layer 104, an attenuation layer 110, and a vinyl layer 108. The optical attenuator assembly 100 of the present disclosure is used for attenuation of the light rays emitted by a light source being tested, preferably a luminaire. Typically, the light intensity of the luminaire being tested has a very high light intensity which may be greater than forty thousand lux. The light intensity of the luminaire ranges from forty thousand lux to one lakh lux which is beyond the operating range of the sensor 106. In an embodiment, the sensor 106 is a photo diode. Upon exposure to such high light intensities the sensor 106 tends to saturate which is not desired.

The protective layer 104 has a cavity (not specifically labelled in the figures) configured thereon. The cavity is firmed so as to receive the sensor 106 which is mounted on the base 102. In an embodiment, the sensor 106 is mounted in a printed circuit board (PCB) which is further securely fixed to the base 102. In an embodiment, the base 102 is an arcuate shaped base 202. In an embodiment, the protective layer 104 is configured to provide a cushioning effect to the sensor 106, and is further configured to prevent the sensor 106 from damage due to external forces. Additionally, the protective layer 104 also provides a certain level of flexibility to the optical attenuator assembly 100 to facilitate easy fitment on the arcuate shaped base 202.

In an embodiment, the base 102 is an aluminum arc base.

Further, the attenuation layer 110 is deposited on the protective layer 104. The attenuation layer 110 is configured to attenuate the intensity of incident light rays, and is further configured to provide the attenuated light rays to the sensor 106 for determining the performance characteristics of the light source. In an embodiment, the attenuation layer 110 is configured to provide two levels of attenuation. The attenuation layer 110 comprises a frosted acrylic film 110b and an attenuation film 110a. In an embodiment, the attenuation film 110a is made of Hybrid Metallized Dye on Polyethylene Terephthalate (PET) Liner.

The vinyl layer 108 is deposited on the attenuation layer 110. The vinyl layer 108 has a window 108a configured thereon to facilitate the light rays to incident on the attenuation layer 110, and is further configured to limit field of view (FOV) of the sensor 106 to receive the incident light rays from a defined area. Further, the window 108a provided by the vinyl layer 108 limits the angle of incident of the incident light rays up to +/−20 degrees with respect to the sensor. That is the width of the window 108a of the vinyl layer 108 defines the field of view of the sensor 106. Further, the position of the window 108a is in line with the position of the sensor 106.

In an embodiment, the height of the vinyl layer 108 is in the range of 60 micrometers to 70 micrometers. Preferably, the height of the vinyl layer 108 is 65 micrometers.

In an embodiment, the height of the protective layer 104 is greater than the height of the sensor 106 so as to provide a sufficient amount distance between the sensor 106 and the window 108a to achieve the desired field of view (FOV). In another embodiment, the height of the protective layer 104 can be suitably varied in order to provide desired field of view (FOV).

In an embodiment, the vinyl layer 108 is 100 percent opaque and only permits the passage of the light rays via the window 108a so as to maintain +/−20 degrees of angle of the sensor 106 with respect to the light rays emitted by the light source being tested, as depicted in FIG. 4. The achieved field of view (FOV) of the sensor provides optimal results as depicted from FIG. 4 which depicts a sensitivity graph depicting response of the sensor 106 for various angle of incident. It is evident from the graph that the sensor 106 provides maximum response at 0 degree angle of incident and provides no response at 90 degrees angle of incident. Therefore, in order to enable the sensor 106 to provide high response the optical attenuator assembly 100 of the present disclosure maintains +/−20 degrees angle of incident with respect to the sensor 106.

In an embodiment, the length of the window 108a is directly proportional to the distance between the sensor 106 and the window 108a of the vinyl layer 108.

In a preferred embodiment, the length of the window 108a is 9 mm. In an embodiment, the length of the window is in the range of 6 mm to 15 mm.

In another embodiment, the material used for manufacturing vinyl layer 108 is either high cal 6000 opaque polymeric PVC or cast polypropylene (CPP).

The frosted acrylic film 110b, of the attenuation layer 110, faces towards the window which is defined by the vinyl layer 108. The frosted acrylic film 110b is configured to provide a first level of attenuation to the incident light rays. The attenuation film 110a is disposed on an operative top surface of the foster acrylic film 110b. The attenuation film 110a is configured to provide a second level of attenuation to the first level attenuated incident light rays. Further, the attenuated light rays from the attenuation layer 110 are received by the sensor 106 which are within the operating range of the sensor 106, thereby enabling the sensor 106 to determine the performance characteristics of the light source, i.e., the luminaire enabling tested.

Referring to FIG. 2, the optical attenuator assembly 100 of the present disclosure is used for an array of sensors mounted in a spaced apart configuration on the arcuate shaped base 202.

Table 1 below indicates the level of attenuation provided by the optical attenuation assembly 100 of the present disclosure to each sensor when used for providing attenuation to 16 sensors mounted on the arcuate shaped base 202.

TABLE 1

| | Input | Output | |
|---|---|---|---|
| | Value | Value | |
| Sensor | (LUX) | (LUX) | Attenuation |
| Sensor 1 | 7890 | 185 | 77.05% |
| Sensor 2 | 8101 | 276 | 78.75% |
| Sensor 3 | 7985 | 207 | 77.78% |
| Sensor 4 | 7999 | 210 | 77.89% |
| Sensor 5 | 7594 | 206 | 73.88% |
| Sensor 6 | 7653 | 210 | 74.43% |
| Sensor 7 | 7538 | 195 | 73.43% |
| Sensor 8 | 7651 | 223 | 74.28% |
| Sensor 9 | 7571 | 198 | 73.73% |
| Sensor 10 | 7739 | 188 | 75.51% |
| Sensor 11 | 7987 | 202 | 77.85% |
| Sensor 12 | 7913 | 217 | 76.96% |
| Sensor 13 | 7852 | 183 | 76.69% |
| Sensor 14 | 7817 | 192 | 76.25% |
| Sensor 15 | 7749 | 201 | 75.48% |
| Sensor 16 | 7061 | 180 | 68.81% |

It is evident from the above Table 1 that the optical attenuator assembly 100 of the present disclosure provides attenuation in the range of 68.81 percent to 78.75 percent, thereby suitably attenuating the light intensity.

In an embodiment, the material used for manufacturing the protective layer 104 is selected from the group consisting of silicon rubber and polyurethane rubber, which advantageously provides for a flexible attenuator assembly that can be positioned on a curved or arcuate surface.

In another embodiment, the height of the protective layer and the attenuation layer is in the range of 1.5 mm to 2.5 mm respectively. Preferably, the height of the protective layer and the attenuation layer is 2 mm.

The optical attenuator assembly 100 of the present disclosure can be used for constant lux type luminaires where the sensor 106 is required to be mounted inside the luminaire assembly to get the actual lux output delivered.

### TECHNICAL ADVANCEMENTS

The present disclosure described herein above has several technical advantages including, but not limited to, the realization of an optical attenuator assembly that:
is cost effective;
is not bulky;
prevents a sensor being tested from damage due to external forces;
provides sufficient field of view (FOV);
has a certain amount of flexibility;
can be easily serviced; and
can be reused for various types of light sensors.

The embodiments herein and the various features and advantageous details thereof are explained with reference to the non-limiting embodiments in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

The use of the expression “at least” or “at least one” suggests the use of one or more elements or ingredients or quantities, as the use may be in the embodiment of the disclosure to achieve one or more of the desired objects or results.

Any discussion of documents, acts, materials, devices, articles or the like that has been included in this specification is solely for the purpose of providing a context for the disclosure. It is not to be taken as an admission that any or all of these matters form a part of the prior art base or were common general knowledge in the field relevant to the disclosure as it existed anywhere before the priority date of this application.

The numerical values mentioned for the various physical parameters, dimensions or quantities are only approximations and it is envisaged that the values higher/lower than the numerical values assigned to the parameters, dimensions or quantities fall within the scope of the disclosure, unless there is a statement in the specification specific to the contrary.

While considerable emphasis has been placed herein on the components and component parts of the preferred embodiments, it will be appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

We claim:

1. An optical attenuator assembly (100) comprising:
a protective layer (104) having a cavity configured thereon to facilitate reception of a sensor (106) mounted on a base (102);
an attenuation layer (110) deposited on said protective layer, and configured to attenuate the intensity of incident light rays, and further configured to provide attenuated light rays to said sensor (106); and
a vinyl layer (108) deposited on said attenuation layer (110), said vinyl layer (108) having a window (108a) configured thereon to facilitate the light rays to incident on said attenuation layer, and further configured to limit the angle of incident of light rays with respect to the sensor.

2. The optical attenuator assembly (100) as claimed in claim 1, wherein said attenuation layer (110) comprises:
a. an frosted acrylic film (110b) facing said window (108a) defined by said vinyl layer (108), and configured to provide a first level of attenuation to said incident light rays; and
b. an attenuation film (110a) disposed on an operative top surface of said foster acrylic film (110b), and configured to provide a second level of attenuation to said first level attenuated incident light rays.

3. The optical attenuator assembly (100) as claimed in claim 1, wherein said protective layer (104) is configured to provide a cushioning effect to said sensor (106), and is further configured to prevent said sensor (106) from damage due to external forces.

4. The optical attenuator assembly (100) as claimed in claim 1, wherein the height of said protective layer (104) is greater than the height of said sensor (106), and is configured to vary the distance between said sensor (106) and said window (108a) so as to achieve a desired field of view (FOV).

5. The optical attenuator assembly (100) as claimed in claim 1, wherein the length of said window (108a) is directly proportional to the distance between said sensor (106) and said window (108a).

6. The optical attenuator assembly (100) as claimed in claim 1, wherein said vinyl layer (108) is configured to limit the angle of incident of said incident light rays up to +/−20 degrees with respect to said sensor (106).

7. The optical attenuator assembly (100) as claimed in claim 1, wherein the length of said window (108a) is in the range of 6 mm to 15 mm.

8. The optical attenuator assembly (100) as claimed in claim 1, wherein the material used for manufacturing said protective layer (104) is selected from the group consisting of silicon rubber and polyurethane rubber.

9. The optical attenuator assembly (100) as claimed in claim 1, wherein said base (102) is an arcuate shaped base (202).

10. The optical attenuator assembly (100) as claimed in claim 1, wherein the height of said protective layer (104) and said attenuation layer (110) is in the range of 1.5 mm to 2.5 mm respectively.

11. The optical attenuator assembly (100) as claimed in claim 1, wherein the optical attenuator assembly (100) is used for an array of sensors (106) mounted in a spaced apart configuration on an arcuate shaped base (202).

12. The optical attenuator assembly (100) as claimed in claim 1, wherein the optical attenuator assembly (100) is flexible, thereby enabling mounting of said optical attenuator assembly (100) on a curved or arcuate surface.
